(19) United States
(12) Patent Application Publication
(10) Pub. No.: US 2018/0245277 A1
(43) Pub. Date: Aug. 30, 2018

(54) MAGNETIC LAUNDRY BAG

(71) Applicant: Itai Yahav, New York, NY (US)

(72) Inventor: Itai Yahav, New York, NY (US)

(21) Appl. No.: 15/445,821

(22) Filed: Feb. 28, 2017

(51) Int. Cl. D06F 95/00; F16B 1/00; B65D 33/14

(52) U.S. Cl. CPC D06F 95/004; F16B 2001/0035; B65D 33/14; F16B 1/00

(57) ABSTRACT

A laundry bag formed of a flexible material has an opening defined by a rim, and a plurality of magnets are held in spaced relationship around a portion of the rim to enable the laundry bag to be adhered to the side of a washing machine while enabling a user to grasp a portion of the rim remote to hold the bag open with one hand while the laundry bag is held to the side of the washing machine.

### FIELD OF THE INVENTION

The present invention relates to a laundry bag having magnets adjacent its opening to enable the bag to be attached to a clothes washing machines fo ease in unloading laundry from the machine into the bag.

### BACKGROUND OF THE INVENTION

Laundry bags are of course well know and typically are made from a fabric material or a mesh and are thus highly flexible. Often when a user needs to empty laundry from a washing machine, the bag is difficult to hold open while clothes are being removed from the machine to be placed in the laundry bag. More rigid laundry bags have been proposed, but such bags have other inconveniences; such as transporting the laundry to and from more remote areas as a domestic basement or to a commercial laundromat. It is, therefor, an object of the present invention to provide a flexible and thus a laundry bag convenient to carry, and yet can be held open with one hand when the user is emptying laundry from a washing machine.

### SUMMARY OF THE INVENTION

According to the present invention, a flexible laundry bag having a rim defining an opening has a series of magnets held around the rim to enable the rim of the laundry bag to be held against a washing machine. In this way, a user with one hand can hold the laundry bag open while it is held to the washing machine to empty the contents of the washing machine into the bag with the other hand.

The present invention is illustrated by way of example in the attached drawing and descriptions, and includes a flexible laundry bag having a plurality of magnets held around an opening therefor.

### BRIEF DESCRIPTION OF THE DRAWINGS

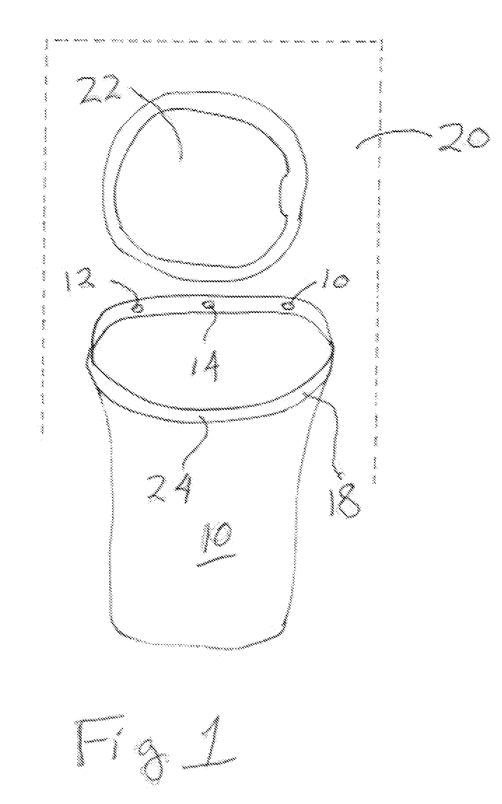

The attached FIG. 1 illustrates schematically a laundry bag according to the present invention.

### DETAILED DESCRIPTION OF AN EMBODIMENT

As shown in FIG. 1, the laundry bag 10 of the present invention includes a plurality of magnets 12, 14 and 16 spaced around the rim 18 of the laundry bag. Preferably, the magnets are sewn into the rim. The laundry bag 10 can be formed of any flexible material, including a light canvas or other fabric, or can be a mesh bag made from a synthetic plastics material. In either event, the laundry bag will not by itself remain open; and this unnecessarily complicates the unloading of washed clothes from a washing machine 20 into the bag by an individual.

To enable the laundry bag 10 to remain open; the magnets 12, 14 and 16 are spaced around the rim 18 so as to be able to be adhered to the side of a washing machine, and as illustrated the magnets are positioned adjacent the opening 22 of a front loading washing machine 20. In this way, the laundry bag 10 can be easily held open by a user grabbing the rim portion 24 opposed to the magnets 12, 14 and 16 with one hand to pull the rim portion 24 away from the magnets held to the side of the washing machine 20, and easily scoop with the other hand the contents of the washing machine from the opening 22 into the laundry bag 10.

As would be well understood by one skilled in the art, the laundry bag 10 of the present invention could also be secured to the side of a top loading washing machine; in which case one hand of the user can pull the rim portion 24 away from the magnets held to the side of the washing machine 20, and the other hand can easily lift the contents of the washing machine from the machine and into the laundry bag 10.

It is to be understood that different materials and configurations for a laundry bag of the present invention could be provided and still be within the spirit and scope of the present invention; which is defined by the appended claims.

What is claimed is:

1. A laundry bag formed of a flexible material and having an opening defined by a rim, and a plurality of magnets held in spaced relationship around a portion of said rim to enable the laundry bag to be adhered to the side of a washing machine thereby enabling a user to grasp a portion of the rim remote from said magnets to hold the bag open with one hand while the laundry bag is held to the side of a washing machine.

2. A laundry bag as set forth in claim 1, including three of said magnets spaced along a side portion of said rim.
